(19) United States
(12) Patent Application Publication
(10) Pub. No.: US 2025/0197556 A1
(43) Pub. Date: Jun. 19, 2025

(54) POLYMER, CROSSLINKED PRODUCT, ELECTRIC WIRE, WIRING HARNESS, METHOD FOR PRODUCING POLYMER, AND METHOD FOR PRODUCING CROSSLINKED PRODUCT

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP); KYUSHU UNIVERSITY, NATIONAL UNIVERSITY CORPORATION, Fukuoka-shi, Fukuoka (JP)

(72) Inventors: Masashi SATO, Yokkaichi-shi (JP); Takehiro HOSOKAWA, Yokkaichi-shi (JP); Tatsuya SHIMADA, Yokkaichi-shi (JP); Makoto MIZOGUCHI, Fukuoka-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP); KYUSHU UNIVERSITY, NATIONAL UNIVERSITY CORPORATION, Fukuoka-shi, Fukuoka (JP)

(21) Appl. No.: 18/726,049

(22) PCT Filed: Dec. 28, 2022
(86) PCT No.: PCT/JP2022/048525

§ 371 Date: Jul. 1, 2024

(30) Foreign Application Priority Data
Jan. 4, 2022 (JP) 2022-000250

(51) Int. Cl. C08G 59/24; C08F 220/32; C08G 59/22; C08G 59/50; C08G 65/26; C08K 5/098; C08L 63/00

(52) U.S. Cl. CPC C08G 59/24; C08F 220/325; C08G 59/223; C08G 59/5006; C08G 65/2615; C08K 5/098; C08L 63/00; C08L 2201/08; C08L 2203/202; C08L 2312/00

(57) ABSTRACT

A polymer and a crosslinked product composed by using the epoxy monomer and the epoxy-modified polymer, respectively, which are excellent in both moldability and heat resistance and which are suitable for covering a metal surface in a peelable manner, an electric wire and a wiring harness using the polymer and the crosslinked product, and methods for producing the polymer and the crosslinked product. A polymer having a structure represented by formula (1) below, wherein a flow-starting temperature is 150° C. or higher, and an acidity of water extract is pH 4 or more and 9 or less, the water extract being a solution obtained by immersing the polymer in 10 times the mass of the polymer of pure water at 120° C. for 24 hours:

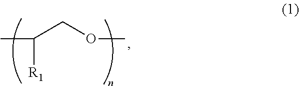

where R₁ refers to an organic group, and n refers to an integer of 2 or larger.

### TECHNICAL FIELD

The present disclosure relates to a polymer, a crosslinked product, an electric wire, a wiring harness, a method for producing the polymer, and a method for producing the crosslinked product.

### BACKGROUND ART

In an insulated wire and a wiring harness, a thermoplastic polymer material has been widely used as an insulation coat covering an outer periphery of a conductor. When a thermoplastic polymer material is molded into a desired shape, the material is heated to obtain fluidity, and then a molding method, such as an extrusion molding, is applied. For simplifying molding by heating, the polymer material should acquire fluidity without heating to an extremely high temperature.

Meanwhile, a temperature rise occurs in the insulated wire or the wiring harness due to energization; accordingly, high heat resistance is required to a polymer material placed in the vicinity of an energized part, including the insulation coat. That is, the polymer material is required to cause no irreversible deformation due to heat generated at the time of energization. For example, the insulation coat of an electric wire for automotive is desired so as not to cause an irreversible deformation at a temperature of 150° C. or lower.

As described above, the polymer material used in the insulated wire or the wiring harness is required to have both moldability, the property of being relatively easily molded by heating, and high heat resistance after being molded. As a technique for achieving both of these characteristics, the method used is that an unpolymerized monomer material is placed at a predetermined position to form a predetermined shape, and thereafter, the monomer material is polymerized. Further, another method used is that an uncrosslinked polymer material is molded into a desired shape by the extrusion molding, and subsequently, a molecular chain is crosslinked to improve heat resistance.

As an example of a material composing the insulated wire and the wiring harness by placing the material at a predetermined position and thereafter undergoing polymerization or crosslinking as described above, an epoxy monomer and an epoxy-modified polymer are included. Through a reaction of ring-opening polymerization of an epoxy group, polymerization of the epoxy monomer or crosslinking of the epoxy-modified polymer progressed. For example, Patent Literature 1, listed below, discloses a form for use in a wire cover by crosslinking an epoxy resin composition.

### CITATION LIST

### Patent Literature

PTL1: JP 2016-89078 A

### SUMMARY OF INVENTION

### Technical Problem

As described above, it is possible to have both moldability and heat resistance by polymerization of the epoxy monomer and crosslinking of the epoxy-modified polymer, respectively; however, polymerization of the epoxy monomer and crosslinking of the epoxy-modified polymer require ring-opening polymerization of an epoxy group, and the ring-opening polymerization of the epoxy group has been conventionally taken place by addition polymerization using a curing agent and cationic polymerization using an initiator.

In the addition polymerization of an epoxy compound, polymerization is progressed by adding a curing agent, such as an amine compound, a thiol-containing compound, a hydroxyl group-containing compound, and an acid anhydride to the epoxy group, as disclosed in Patent Literature 1. When this addition polymerization takes place, a hydroxyl group is generated, and when the addition polymerization takes place on a surface of a metal material, such as the conductor, an epoxy polymer is adhered to the surface of the metal via the hydroxyl group, making peeling difficult. Therefore, it becomes inapplicable for usage, such as a wire cover, where peeling is required. Further, when using the addition polymerization, the curing agent is required to be added at an equal or approximately equal molar amount to the epoxy group, and the addition polymerization is progressed immediately after adding the curing agent, even in a relatively low temperature, such as room temperature. Therefore, prior preparation is required, and controlling a polymerization speed is also difficult. For this reason, it is hardly said that moldability is excellent.

Meanwhile, in the cationic polymerization of the epoxy compound, an acidic initiator, such as a photo-acid generator or a Lewis acid, is used. Because no hydroxyl group is generated in this case, no adhesion to the surface of a metal occurs as in the addition polymerization. However, after undergoing the cationic polymerization, acid remains in a material, and the acid can cause corrosion to a metal material; accordingly, it becomes inapplicable for usage in contact with the metal material.

Given the above, it is an object of the present invention to provide a polymer and a crosslinked product composed by using an epoxy monomer and an epoxy-modified polymer, respectively, which are excellent in both moldability and heat resistance and are suitable for covering a metal surface in a peelable manner, an electric wire and a wiring harness using the polymer and the crosslinked product, and methods for producing the polymer and the crosslinked product.

### Solution to Problem

A polymer according to the present disclosure has a structure represented by formula (1) below, wherein the polymer has a flow-starting temperature of 150° C. or higher, and when the polymer is immersed in pure water in 10 times the mass of the polymer at 120° C. for 24 hours to obtain water extract, the water extract has an acidity of pH 4 or higher and 9 or lower:

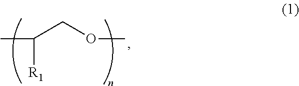

where R1 is an organic group and “n” is an integer of 2 or larger.

A crosslinked product according to the present disclosure has a structure represented by formula (3) below, wherein the crosslinked product has a flow-starting temperature of 150° C. or higher, and when the crosslinked product is immersed in pure water in 10 times the mass of the polymer at 120° C. for 24 hours to obtain water extract, the water extract has an acidity of pH 4 or higher and 9 or lower:

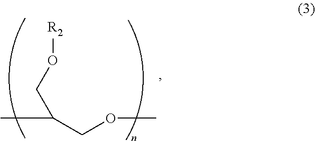

where R₂ is a polymer chain and “n” is an integer of 2 or larger.

An electric wire according to the present disclosure includes a conductor composed of a metal, and an insulation coat including the polymer or the crosslinked product, covering an outer periphery of the conductor.

A wiring harness according to the present disclosure includes the polymer or the crosslinked product.

A method for producing a polymer according to the present disclosure, including a step of heating a composition including an epoxy monomer represented by formula (2) below and the fatty acid salt to cause a polymerization reaction, to thereby produce a polymer.

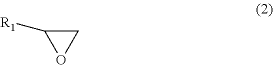

A method for producing a crosslinked product according to the present disclosure, including a step of heating a composition including an epoxy-modified polymer represented by formula (4) below and the fatty acid salt to cause a crosslinking reaction, to thereby produce a crosslinked product:

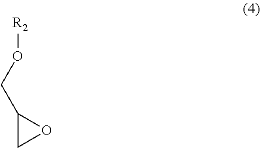

### Advantageous Effects of Invention

The polymer and the crosslinked product according to the present disclosure are composed by using the epoxy monomer and the epoxy-modified polymer, respectively, which are excellent in both moldability and heat resistance and which are suitable for covering a metal surface in a peelable manner. Further, the electric wire, the wiring harness, and methods for producing the polymer and the crosslinked product according to the present disclosure correspond to an electric wire and a wiring harness using such a polymer and a crosslinked product, and methods for producing such a polymer and a crosslinked product.

### BRIEF DESCRIPTION OF DRAWINGS

FIG. 1 is a view illustrating a structure for forming a polymer according to an embodiment of the present disclosure.

FIG. 2 is a side view showing a structure of an electric wire according to an embodiment of the present disclosure.

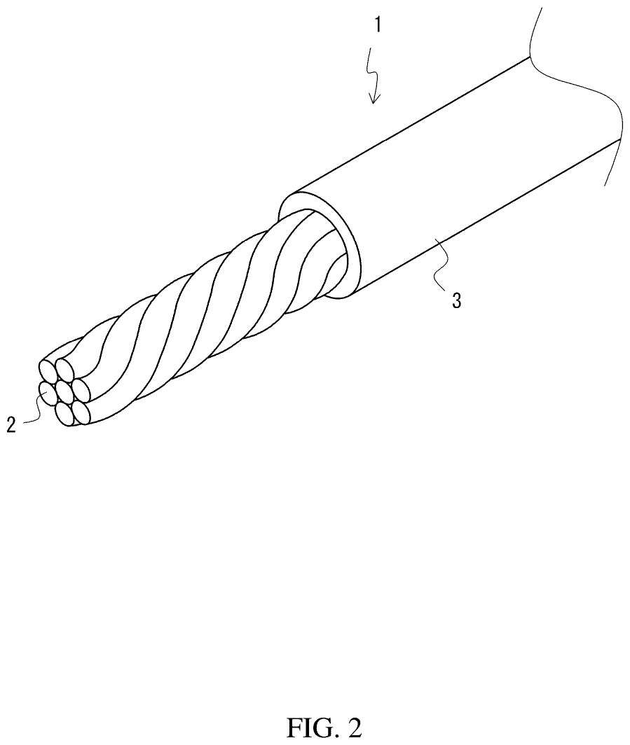

FIG. 3 is an infrared absorption spectrum of a material corresponding to sample A5, indicating (i) the status before heating an epoxy compound (OD-ep) alone, (ii) the status after heating (i), (iii) the status before heating a mixed solution with a fatty acid salt (st-Mg), and (iv) the status after heating the mixed solution.

### DESCRIPTION OF EMBODIMENTS

### Description of Embodiments of the Present Disclosure

First, embodiments of the present disclosure will be listed and described.

A polymer has a structure represented by formula (1) below, wherein the polymer has a flow-starting temperature of 150° C. or higher, and when the polymer is immersed in pure water in 10 times the mass of the polymer at 120° C. for 24 hours to obtain water extract, the water extract has an acidity of pH 4 or higher and 9 or lower:

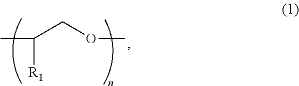

where R₁ is an organic group and “n” is an integer of 2 or larger.

A structure represented by formula (1) above is formed by ring-opening polymerization of an epoxy monomer represented by formula (2) below by a fatty acid salt.

A crosslinked product according to the present disclosure has a structure represented by formula (3) below, wherein the crosslinked product has a flow-starting temperature of 150° C. or higher, and when the crosslinked product is immersed in pure water in 10 times the mass of the polymer at 120° C. for 24 hours to obtain water extract, the water extract has an acidity of pH 4 or higher and 9 or lower:

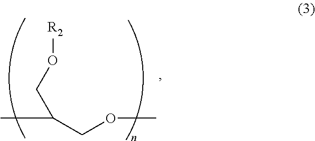

where R₂ is a polymer chain and “n” is an integer of 2 or larger.

A structure represented by formula (3) above is obtained by the ring-opening polymerization of an epoxy-modified polymer represented by formula (4) below by the fatty acid salt.

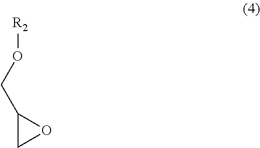

The epoxy monomer represented by formula (2) above and the epoxy-modified polymer represented by formula (4) above, which are before undergoing the ring-opening polymerization, are in a fluid state or a softened state; accordingly, they are allowed to be easily placed at a predetermined position, such as a surface of metal to take a desired shape. Further, the ring-opening polymerization does not progress when the epoxy monomer or the epoxy-modified polymer is brought into contact with the fatty acid salt at a relatively low temperature, such as room temperature. Accordingly, the polymer and the crosslinked product according to the present disclosure are excellent in moldability in the state of raw material before heating. Meanwhile, when a reaction of the ring-opening polymerization takes place by heating, a polymerization structure represented by formula (1) or a crosslinking structure represented by formula (3) is formed, resulting in exhibiting high heat resistance in which flow starts only at a high temperature of 150° C. or higher. As described above, the polymer and the crosslinked product according to the present disclosure have both moldability and heat resistance. Further, the ring-opening polymerization of an epoxy compound by the fatty acid salt does not generate a hydroxyl group or require an acid substance; accordingly, the obtained polymer and the crosslinked product become approximately neutral in which the water extract has the acidity of pH 4 or higher and 9 or lower. For this reason, adhesion to a metal surface via the hydroxyl group and corrosion of a metal surface hardly occur, allowing the polymer and the crosslinked product to be suitable for covering a metal surface in a peelable manner.

Here, the polymer preferably includes no compound causing the ring-opening polymerization of the epoxy group, except for the fatty acid salt. Further, the crosslinked product preferably includes no compound causing the ring-opening polymerization of the epoxy group, except for the fatty acid salt. As described above, the polymer and the crosslinked product according to the present disclosure can be formed by the ring-opening polymerization of the epoxy compound by the fatty acid salt. Accordingly, there is no need to add a compound, such as a crosslinking agent for addition polymerization or an initiator for cationic polymerization, for the ring-opening polymerization of the epoxy group. The absence of these compounds can prevent addition polymerization or cationic polymerization of the epoxy compound from taking place, whereby contributing to suppressing an occurrence of a phenomenon associated with the addition polymerization or the cationic polymerization, such as adhesion to or corrosion of a metal surface. Compounds causing the ring-opening polymerization of the epoxy group shall also include a chemical species that is derived from the compound and remains after undergoing the ring-opening polymerization.

An electric wire according to the present disclosure includes a conductor including a metal, and an insulation coat including the polymer or the crosslinked product, covering an outer periphery of the conductor. As described above, the polymer and the crosslinked product according to the present disclosure are excellent in both moldability and heat resistance; accordingly, the insulation coat can be easily formed on the outer periphery of the conductor with a desired thickness; furthermore, deformation or denature is hardly occurred when heated by energization of the conductor. Further, the polymer and the crosslinked product according to the present disclosure do not cause adhesion to a metal surface; accordingly, a peeling operation of the insulation coat can be easily performed when a terminal is connected to a terminal portion of the electric wire. In addition, the polymer and the crosslinked product according to the present disclosure can hardly cause metal corrosion; accordingly, the conductor can be prevented from being corroded in the electric wire.

A wiring harness according to the present disclosure includes the polymer or the crosslinked product. The polymer and the crosslinked product according to the present disclosure can be used as a material for composing the wiring harness for various applications in addition to the insulation coat of the electric wire as described above, such as curing or molding materials for covering an exposed part of the conductor. Further, by taking advantage of the excellence in moldability and heat resistance of the polymer and the crosslinked product, a molding operation into a desired shape can be easily performed for each usage while suppressing an influence of heat generated by energization or heat that comes from surrounding environment.

A method for producing the polymer according to the present disclosure includes a step of heating a composition including an epoxy monomer represented by formula (2) below and the fatty acid salt to cause the polymerization reaction, thereby producing a polymer.

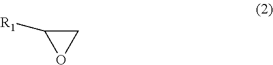

A method for producing the crosslinked product according to the present disclosure includes a step of heating a composition including an epoxy-modified polymer represented by formula (2) below and the fatty acid salt to cause a crosslinking reaction, thereby producing a crosslinked product.

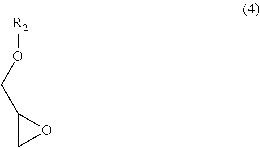

In methods for producing the polymer and the crosslinked product, respectively, according to the present disclosure, the ring-opening polymerization of the epoxy group is caused by the fatty acid salt when heated, and the polymer and the crosslinked product are obtained. The ring-opening polymerization does not progress at a low temperature, such as room temperature; accordingly, the composition can be simply placed at a desired position to form a desired shape before heating. Accordingly, high moldability can be obtained. Meanwhile, the polymer and the crosslinked product obtained through heating can obtain high heat resistance. In addition, there is no need to use a compound causing adhesion to or corrosion of a metal surface for the ring-opening polymerization of the epoxy group; accordingly, the methods for producing the polymer and the crosslinked product, respectively, can be suitable for the application peelably covering the surface of the metal material.

Here, the polymerization reaction preferably starts at a temperature of 100° C. or higher, and the crosslinking reaction preferably starts at a temperature of 100° C. or higher. Then, the epoxy compound, before undergoing polymerization or crosslinking, does not cause the polymerization or crosslinking reactions at 100° C. or lower and remains in a fluid or soft state. Therefore, high moldability can be secured before heating.

### Details of Embodiments of the Present Disclosure

A polymer, a crosslinked product, an electric wire, a wiring harness, a method for producing the polymer, and a method for producing the crosslinked product according to an embodiment of the present disclosure will be described in detail. Note that the present disclosure is not limited to these embodiments.

### [1] Polymer and Method for Producing Polymer

First, a polymer and a method for producing the polymer according to an embodiment of the present disclosure will be described. The polymer according to the present embodiment has a structure represented by the following formula (1):

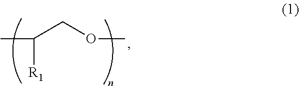

where R₁ is an organic group and “n” is an integer of 2 or larger. The polymer according to the present embodiment has a flow-starting temperature of 150° C. or higher and the acidity of water extract is pH 4 or higher and 9 or lower. Here, the water extract refers to a solution obtained by immersing the polymer in pure water in 10 times (on a mass basis) of the polymer at 120° C. for 24 hours (the same applies hereafter to water extract).

In formula (1), R₁ can be an arbitrary organic group. R₁ preferably includes a heteroatom, such as an oxygen atom, within a hydrocarbon group or in the middle of or at ends thereof. In these cases, although a type of the hydrocarbon group is not particularly limited, any one of an alkyl group, an alkylene group, and an aromatic ring group is preferable. Further, the hydrocarbon group may have a brunch structure or a substituent group. Meanwhile, it is not preferable to include such a substituent group, which can cause a polymerization reaction of an epoxy compound through a reaction pathway other than ring-opening polymerization of an epoxy group by a fatty acid salt described later, or which causes a bonding or a reaction between the fatty acid salt. As the substituent groups that are not preferable to be added, an amino group, a thiol group, and an acid-anhydride group are included.

A structure including a hetero atom in the middle of or at the ends of the hydrocarbon group refers to a structure that bonds between carbon atoms via the hetero atom, such as an ester bond or an ether bond. R₁ preferably takes a structure of bonding carbon atoms adjacent to the epoxy group via the ether bond or a glycidyl ester structure of bonding the carbon atom adjacent to the epoxy group via the ester bond. Further, when the substituent group is bonded to the hydrocarbon group, the substituent group may be bonded by the ester bond or the ether bond which has a structure of bonding via the hetero atom.

The number of carbon atoms of R₁ is not particularly limited; however, from the viewpoint of enhancing heat resistance of the polymer, the number is preferably 3 or more or still preferably 4 or more. Meanwhile, from the viewpoint of securing high fluidity in the epoxy monomer before polymerization, the number of carbon atoms is preferably 30 or less, or still preferably 22 or less.

In formula (1), “n” refers to a degree of polymerization of the polymer. The value “n” is not particularly limited, but from the viewpoint of enhancing heat resistance of the polymer, the value is preferably 5 or larger and more preferably 30 or larger. Meanwhile, from the viewpoint of securing high flexibility in the polymer, “n” is preferably 500 or smaller and more preferably 200 or smaller.

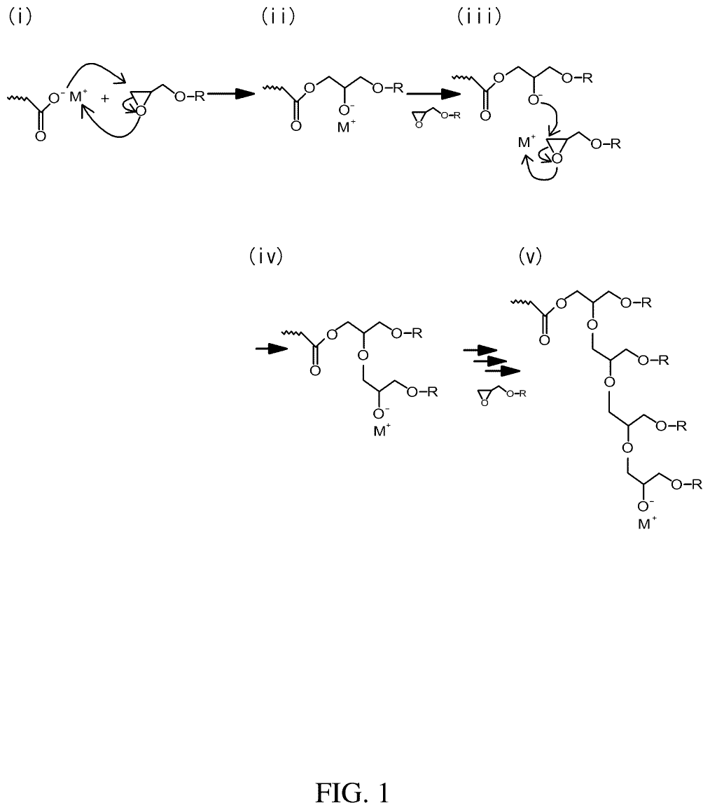

A fatty acid ester structure or an alkoxymetallic structure may remain at a terminal portion of the polymer, the fatty acid ester structure or an alkoxymetallic structure being derived from the fatty acid salt used for the polymerization reaction described next (see FIG. 1 (v)), as appropriate. Further, although the polymer is preferably composed of a repeating unit of formula (1) alone, except for end portions, a structure of R₁ part in formula (1) may be appropriately composed of a copolymer including approximately two or more different repeating units. Further, in addition to a block composed of the repeating unit of formula (1), a block copolymer composed of other kinds of repeating units may be allowed.

The polymer takes a structure in which a skeleton ( . . . —O—C—C—O—C—C—O— . . . ) having the ether bond constitutes a main chain to which R₁ part is bonded as a side chain. A structure of the main chain is stable in heat; accordingly, the polymer exhibits high heat resistance. As described in embodiments described later, the flow-starting temperature of the polymer (i.e., a melting point or a flow point; if having both of them, the lower one) becomes a high temperature of 150° C. or higher. The higher the number of carbon atoms of R₁ being employed and the larger the degree of polymerization “n,” the higher the flow-starting temperature of the polymer tends to be. If the number of carbon atoms is 5 or more and the degree of polymerization “n” is 10 or larger, the flow-starting temperature can be relatively easily achieved at 150° C. or higher. The flow-starting temperature is more preferably 200° C. or higher or 230° C. or higher. In addition, the flow-starting temperature is preferably increased by 10° C. or more or even more preferably 50° C. or more by the polymerization.

The polymer represented by formula (1) is formed by the ring-opening polymerization of an epoxy monomer represented by formula (2) below by the fatty acid salt. More specifically, a composition including the epoxy monomer represented by formula (2) and the fatty acid salt is heated, thereby causing the polymerization reaction.

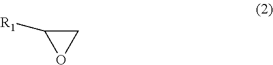

Here, the structure of R₁ is as described above in formula (1). An epoxy equivalent amount of the epoxy monomer is preferably approximately 100 g/eq or more and 500 g/eq or less. The epoxy monomer may be a monoepoxy compound including one epoxy group alone in one molecule or a polyepoxy compound including two or more epoxy groups. In the polyepoxy compound, one or a plurality of epoxy groups are also included in R₁ part of formula (2). Further, in the polymer formed by such a polyepoxy compound, R₁ part in formula (1) includes a polymerized structure obtained by ring-opening polymerization of the epoxy group (in this case, R₁ part in formula (1) is structured to have a plurality of R₁ parts in formula (2) bonded together through a structure obtained by the ring-opening polymerization of the epoxy group.)

A structure of the polymerization reaction will be described in FIG. 1. That is, as shown in structure (i), heat is applied to the fatty acid salt (here, referring to a metal soap having a structure of —COO⁻M⁺ at ends; “M” refers to metal) and the epoxy compound (here, referring to the glycidyl ester) which are present in a coexisting state, electronic transfer occurs between them, and a new bond is formed therebetween. More specifically, a carboxylate anion at the ends of the fatty acid salt reacts with the epoxy group of the epoxy compound first, whereby formation of an ester structure and a ring-opening of the epoxy group take place. Due to this mechanism, an alkoxy metal intermediate is formed, as shown in structure (ii). Further, the alkoxy metal intermediate includes a metal cation that withdraws an electron from the epoxy group of a newly-formed epoxy-compound molecule, as shown in structure (iii), and the ring-opening of the epoxy group takes place. This mechanism allows forming of a new alkoxy metal intermediate into which one ring-opened epoxy compound is newly inserted, as shown in structure (iv). As described above, the polymerization reaction proceeds by repeating the ring-opening and the bonding of the epoxy group by the alkoxy metal intermediate. Due to this mechanism, many ring-opened epoxy compounds are bonded, thereby forming the polymer including the main chain having the ether bond, as in . . . —O—C—C—O—C—C—O— . . . , as shown in structure (v). The polymer formed as mentioned above corresponds to the polymer represented by formula (1).

A type of fatty acid salt for use in the polymerization reaction is not specifically limited; however, using a long-chain fatty acid metal salt called metal soap is preferable. Usually, a mixture of the fatty acid salt and the epoxy compound is stable at room temperature or around room temperature. Further, the starting temperature of the polymerization reaction is preferably 100° C. or higher or more preferably 150° C. or higher. Then, the mixture of the fatty acid salt and the epoxy compound can be stably maintained without making them react. Meanwhile, by heating the mixture at a higher temperature than the reaction starting temperature of the polymerization reaction, the polymer having a structure represented by formula (1) is obtained. In addition, the fatty acid salt preferably has a melting point of 300° C. or lower or more preferably 250° C. or lower. When the fatty acid salt is melted into liquid, high reaction speed with the epoxy compound can be obtained, while heating at 300° C. or higher can cause decomposition of the epoxy compound; accordingly, the fatty acid salt is preferably melted at 300° C. or lower and thereafter subjected to be reacted. The starting temperature of the polymerization reaction can be controlled depending on a specific structure of the fatty acid salt and the epoxy compound. For example, when compatibility of the fatty acid salt and the epoxy compound becomes higher, dispersion or dissolution of the fatty acid salt occurs in the epoxy compound at a lower temperature; accordingly, the reaction starting temperature becomes lower. More specifically, because the epoxy compound does not usually have a polar group, such as a hydroxyl group, a carboxyl group, or an amino group, the fatty acid salt preferably has a long chain (the number of carbon atoms is 9 or more, for example) when the reaction starting temperature is controlled to be lower, and a metal forming a salt is preferably the one which can form an ion belonging to a soft acid in HSAB principle (a transition metal including zinc or copper, for example). On the other hand, when the reaction starting temperature is controlled to be higher, the fatty acid salt preferably has a short chain (the number of carbon atoms is 8 or less, for example), and includes a metal (a typical metal including lithium, magnesium, for example) which can form an ion belonging to a hard acid.

The number of carbon atoms of the fatty acid salt is preferably 4 or more and still preferably 6 or more. This is because the fatty acid salt has an organic nature strongly; the melting point of the fatty acid salt becomes low, and the compatibility with the epoxy compound becomes excellent. Meanwhile, from the viewpoints of availability and maintaining higher metal content in a molecule, the number of carbon atoms of the fatty acid salt is preferably 30 or less, more preferably 24 or less. As the fatty acid salt, Behenate, stearate, palmitate, myristate, laurate, caprate, caprylic, erucate, oleate, and palmitoleate may be listed as suitable examples. The metal type composing the metal soap is not specifically limited and may be univalent, bivalent, or more. In any valence, the alkoxy metal intermediate, as shown in FIG. 1(ii) or (iii), can be stably formed. As a metal, an alkali metal including Li, an alkali earth metal including Mg or Ca, and Zn may be listed as suitable examples.

In a composition including the epoxy monomer and the fatty acid salt to be a polymerization raw material, the amount of addition of the fatty acid salt is preferably 0.1 mass % or more or still preferably 1 mass % or more with respect to the epoxy monomer. As shown in structure (iii) of FIG. 1, in a polymerization process of the epoxy monomer, once the alkoxy metal intermediate is formed, bonding of a newly-formed ring-opened epoxy compound is catalytically repeated, the bonding takes place due to withdrawal of an electron from the epoxy group. Therefore, it is not necessary to add the fatty acid salt in an equal molar amount of the epoxy monomer or approximately equal amount thereof to form the polymer. The reaction can be sufficiently progressed by adding the maximum amount or less. However, if the amount of the fatty acid salt is too small, the progress of the polymerization reaction becomes slow, and the alkoxy metal intermediate can be deactivated before polymerization is sufficiently progressed, therefore, it is preferable to add the amount of the fatty acid salt at the lower limit or more. Adding a large amount of fatty acid salt can lead to decreased physical properties of the polymer; accordingly, it is preferable to set an amount of the fatty acid salt to an extent that the polymerization reaction can be performed without excess or deficiencies.

As mentioned above, the mixture of the fatty acid salt and the epoxy compound is stably present without occurrence of the polymerization reaction up to a temperature (around 100° C., for example), which is higher to some extent from room temperature. Accordingly, during storing or preparation of the polymerization raw material, a temperature should be kept within a range that can keep the stability while heat should be applied up to a temperature at which the reaction of the ring-opening polymerization described in FIG. 1 occurs, at 100° C. or higher or further 150° C. or higher, for example, at the time when the polymerization reaction is initiated. In addition, the fatty acid salt is preferably melted at the temperature. At the time of the polymerization reaction, the reaction speed can be controlled by adjusting a heating temperature. As the temperature becomes higher, the speed of the polymerization reaction becomes faster. Meanwhile, a reaction temperature is preferably kept around 300° C. or lower or a further 250° C. or lower because the epoxy compound can be decomposed by being overheated to a high temperature. The polymerization reaction can take place by heating the mixture within an organic solvent.

The polymer according to the present embodiment can be formed by heating the composition, including the fatty acid salt and the epoxy monomer, as described above. In an unpolymerized state, the compound is in a highly fluid or soft state. The unpolymerized composition can be placed at a predetermined position, such as an outer periphery of a conductor of an electric wire as described later, to take a desired shape by extrusion molding or applying it in liquid form, and thereafter the composition is polymerized; accordingly, the polymer is excellent in moldability. In addition, the polymerization reaction does not progress at a low temperature, such as room temperature; accordingly, unintentional progress of the polymerization reaction does not take place during preparation or molding of the composition, which also allows the polymer to have excellent moldability. Meanwhile, after polymerization, the polymer according to the present embodiment becomes a stable polymer chain, including the ether bond, as well as having high heat resistance in which the flow-starting temperature of 150° C. or higher. Therefore, the polymer can be suitably applied for usage to which heat is applied, such as an insulation coat of the electric wire, for example. As described above, the polymer according to the present embodiment has both moldability and heat resistance.

Further, the polymer according to the present embodiment can be obtained through formation of the alkoxy metal intermediate by the withdrawal of an electron from the epoxy group by the fatty acid salt as described in FIG. 1, and no acid or base is required for the reaction. In addition, in the reaction process, no byproduct, including a proton or a hydroxyl group, is released from the fatty acid salt or the epoxy monomer. Therefore, the obtained polymer becomes neutral or approximately neutral, and water extract indicates acidity of pH 4 or more and 9 or less. The acidity of pH 6 or more and 8 or less is further preferable.

As described above, the polymer does not include an acid or a base derived from the polymerization raw material or a byproduct of the polymerization; accordingly, the polymer according to the present embodiment can be applied for usage that peelably covers the metal surface. That is, if the polymer includes the hydroxyl group, the polymer shows an adhesive effect on the metal surface by electrostatic interaction with the metal surface, especially hydrogen bonding between the hydroxyl group formed on the metal surface due to water molecule cleavage; however, the polymer according to the present embodiment does not substantially include the hydroxyl group, and the polymer does not show an adhesive effect to the metal surface; accordingly, a peelable state is maintained. The above-mentioned fact is different from the case where the polymerization of the epoxy monomer is carried out by the addition polymerization using a curing agent, such as an amine or a hydroxyl-group containing compound, and an adhesion enough to be used as an adhesive agent is shown to the metal surface. When forming the epoxy polymer by the addition polymerization using the curing agent, the adjacent ring-opened epoxy compounds are not directly bonded as shown in formula (1), and a crosslinking structure using the curing agent is interposed between them. In addition, the polymer according to the present embodiment does not include acid; accordingly, corrosion of the covered metal surface can be prevented. The above-mentioned fact is different from the case where polymerization of the epoxy monomer is carried out by a cationic polymerization, which requires using an acidic initiator including a Lewis acid, and an acidic component remaining in a material can cause corrosion of the metal material. The fact that no byproduct is produced at the time of polymerization means that the shape of the material hardly changes before and after polymerization, in addition to the polymer being kept neutral or approximately neutral, and these facts enhance convenience in molding. The polymer according to the present embodiment is preferable not to include acid or basic groups in a part of R₁ structure of formula (1) or a repeating unit in the case where a repeating unit other than formula (1) is included.

The polymer according to the present embodiment may be used alone for usage, such as covering a metal surface, and may appropriately include other components by adding to a composition before polymerization. As a component to be added as described above, a polymer component other than the epoxy polymer in formula (1) can be included. The polymer component other than the epoxy copolymer includes polyolefin, polyester, and polyurethane. In addition, an additive other than the polymer component includes a flame retardant, a copper damage inhibitor, an antioxidant, and a colorant.

Meanwhile, the components including acid or basic groups are not preferably added to the polymer according to the present embodiment. As the whole polymer material including the component to be added, the water extract preferably has the acidity of pH 4 or more and 9 or less. Further, the polymer and the composition as a raw material of the polymer according to the present embodiment are preferable not to include a compound causing the ring-opening polymerization of the epoxy group, except for the fatty acid salt. As described by referring to FIG. 1, the polymer according to the present embodiment can sufficiently progress the polymerization reaction only by the fatty acid salt; accordingly, no other compound causing the ring opening polymerization of the epoxy group is required to be used. The use of such a compound may result in the formation of an acid or a base in the polymer material, which may impair the suitability of the polymer according to the present embodiment to usages peelably covering a metal surface.

Compounds which cause the ring-opening polymerization of the epoxy group and which are not preferably added can be listed as follows:
curing agents causing the addition polymerization of the epoxy compound: an amine compound, a thiol compound, a hydroxyl-containing compound, an acid anhydride, an isocyanate, and an isothiocyanate.
initiators causing the cationic polymerization of the epoxy compound: iodonium compounds, sulphonium compounds, fluorophosphate compounds, fluoroborate compounds, fluorophenylborate compounds, fluoroanthimonate compounds, fluoroacetate compounds, fluoromethanesulphonic acid compounds, p-toluenesulphonic acid compounds.

In addition, for other compounds acting in different structures from the curing agents or initiators, a cationic polymerization initiator and a radical polymerization initiator are not preferably added.

Each of the compounds and additives described above shall also include a chemical species derived from these compounds and additives that remain in the material after undergoing a reaction, such as the ring-opening polymerization of the epoxy group, and these chemical species are not preferably mixed in the polymer.

### [2] Crosslinked Product and Method for Producing the Same

Next, a crosslinked product and a method for producing the crosslinked product will be described.

The crosslinked product according to the present embodiment includes a structure of formula (3) below:

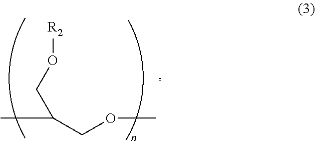

where R₂ is a polymer chain and “n” is an integer of 2 or larger.

Further, the crosslinked product according to the present embodiment has a flow-starting temperature of 150° C. or higher and the water extract has the acidity of pH 4 or higher and 9 or lower.

In formula (3), R₂ can be an arbitrary polymer chain. Here, a polymer having a relatively lower polymerization degree, such as an oligomer chain, is also included in the polymer. R₂ preferably includes a heteroatom in the form of the ester bond or the ether bond within a polyolefin chain or in the middle of or at ends thereof. These polyolefin chains may have a brunch structure or the substituent group. However, the substituent group does not preferably include a functional group that can cause a reaction of the epoxy compound in a reaction pathway other than that of the ring-opening polymerization of the epoxy group by the fatty acid salt, or the substituent group, which can cause a bonding or a reaction with the fatty acid salt. In addition, acidic or basic substituents are not preferably included.

A structure of formula (3) corresponds to a state in which a plurality of polymer chains R₂ are crosslinked via a structure of —C—C—O—. “n” indicates the number of crosslinked polymer chains, and “n” is preferably 3 or more, for example, although not limited. Meanwhile, “n” is preferably 100 or less. In addition, one polymer chain is preferable to have a plurality of crosslinking parts. The crosslinked polymer chain R₂ may be of one kind or two or more different kinds mixed to be crosslinked.

The crosslinked product takes a structure in which the polymer chain is crosslinked by a crosslinking site having a structure of —C—C—O—. The crosslinking site is thermally stable, and the crosslinked product becomes to have high heat resistance. In practice, as described later in embodiments, the crosslinked product has a high flow-starting temperature of 150° C. or higher. Still preferably, the flow-starting temperature is 200° C. or higher or 270° C. or higher. The higher a flow-starting temperature of R₂ being employed, the higher the flow-starting temperature of the crosslinked product tends to be. For example, it is preferable to employ an uncrosslinked epoxy-modified polymer in formula (4) having a flow-starting temperature of 50° C. or higher and more preferably 80° C. or higher. In addition, the flow-starting temperature is preferably increased by 10° C. or more or even more preferably 50° C. or more by the formation of the crosslinking structure.

The polymer in formula (3) above can be formed by undergoing the ring-opening polymerization of the epoxy-modified polymer represented by formula (4) below by the fatty acid salt. More specifically, a composition including the epoxy-modified polymer represented by formula (4) and the fatty acid salt is heated to cause a crosslinking reaction.

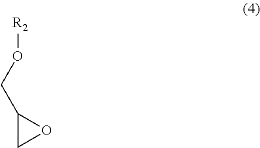

Here, a structure of R₂ is as described in formula (3). The epoxy group may be included in a main chain of the polymer chain R₂; however, from the viewpoint of high reactivity, the epoxy group is preferably included in a side chain in the form of a glycidyl ester. Further, one polymer chain preferably includes a plurality of epoxy groups. An epoxy equivalent amount of the epoxy-modified polymer is preferably approximately 100 g/eq or more and 500 g/eq or less.

The crosslinking reaction progresses via the formation of the alkoxy metal intermediate, which is a mechanism similar to the polymer according to an embodiment of the present disclosure described above with reference to FIG. 1. Therefore, the uncrosslinked epoxy-modified polymer and the fatty acid salt are mixed then placed a predetermined position to take a predetermined shape, subsequently heated, whereby the crosslinking reaction accompanied with the ring-opening of the epoxy group may be progressed. A reaction starting temperature of the crosslinking reaction is preferably 100° C. or higher or 150° C. or higher. The starting temperature of the crosslinking reaction may be controlled by specific structures of the fatty acid salt and the epoxy-modified polymer. For example, when compatibility of the fatty acid salt and the epoxy compound becomes higher, dispersion and dissolution of the fatty acid salt occur in the epoxy compound at a lower temperature; accordingly, the reaction starting temperature becomes lower. More specifically, for a structure of the fatty acid salt to control the reaction starting temperature to be lower or higher, the same one listed above for the polymerization reaction may be applied.

When the flow-starting temperature of the epoxy-modified polymer is as low as below 100° C. which is lower than that at which the crosslinking reaction takes place, the epoxy-modified polymer and the fatty acid salt are kneaded at a temperature lower than that at which the crosslinking reaction is taken place, thereby obtaining an uncrosslinked mixed material. Meanwhile, when the flow-starting temperature of the epoxy-modified polymer is as high as 100° C. or higher, which is higher than that at which the crosslinking reaction takes place, the epoxy-modified polymer and the fatty acid salt are dissolved in an organic solvent, mixed at a temperature lower than that at which the crosslinking reaction takes place then dried, thereby obtaining an uncrosslinked mixed material. The mixed material obtained by these methods is molded into a predetermined shape by extrusion molding and heated as high as 100° C. or higher, which is higher than the reaction starting temperature of the crosslinking reaction, thereby obtaining the crosslinked product represented by formula (3). In this case, if a temperature at which the mixed material is molded by the extrusion molding is set to a high temperature (150° C. or higher, for example) enough to obtain high crosslinking speed, crosslinking can be performed simultaneously with molding.

The differences between the polymer represented by formula (1) and the crosslinked product represented by formula (3), as well as the epoxy monomer represented by formula (2) and the epoxy-modified polymer represented by formula (4) are only that R₁ site is an organic group, not the polymer chain, while R₂ site is a polymer chain. Therefore, in the crosslinking reaction as well, a structure of the reaction taking place with the fatty acid salt is the same as that described for the polymerization reaction with reference to FIG. 1, and the content of the explanation for the polymer described above is applied directly to the crosslinked product. Therefore, the descriptions for the polymer mentioned above, including a structure or the addition amount of the fatty acid salt, reacting conditions including a reaction temperature, other components to be added, other components not to be added, and usages for the polymer apply directly to the crosslinked product by reading R₁ as R₂, and polymer as crosslinked product, as appropriate.

The selection of whether to use the polymer or the crosslinked product may be made depending on a usage and a location of application. For example, the epoxy-modified polymer, the raw material of the crosslinked product, has a higher viscosity than the epoxy monomer, the raw material of the polymer; accordingly, the polymer is more suitable for application and molding in a liquid state, while the crosslinked product is more suitable for molding by extrusion molding.

### [3] Electric Wire and Wiring Harness

The polymer and the crosslinked product according to the embodiment of the present disclosure described above may be suitably used for a usage where heat resistance is required and a metal material is peelably covered. As examples of such an application, an electric wire and a wiring harness will be briefly described. FIG. 1 shows a structure of an example of an electric wire. An electric wire 1 includes a conductor 2 including a metal material, an insulation coat 3 covering an outer periphery of the conductor 2. The insulation coat 3 includes the polymer or the crosslinked product according to an embodiment of the present disclosure described above.

The diameter and material type of the conductor 2 are not specifically limited and are selected as appropriate depending on the usage of the electric wire 1. As a material for composing the conductor 2, a metal material including copper, copper alloy, aluminum, and aluminum alloy are suitably used. The conductor 2 may be composed of a single wire, however, from the viewpoint of securing flexibility, the conductor 2 may be preferably composed of a wire strand in which a plurality of elemental wires are twisted together.

The polymer and the crosslinked product according to an embodiment of the present disclosure are excellent in moldability; accordingly, the insulation coat 3, having a predetermined thickness, can be formed onto an outer periphery of the conductor 2 without any difficulty. In addition, the polymer and the crosslinked product have high heat resistance; accordingly, the insulation coat 3 is hardly deformed or deteriorated even when the insulation coat 3 is subjected to heat by energization of the conductor 2. Further, the polymer and the crosslinked product are composed of nearly neutral materials; accordingly, the conductor 2 is less likely to be corroded by acid, and the insulation coat is easily peeled off at end portions of the electric wire 1.

The wiring harness according to an embodiment of the present disclosure includes the polymer and the crosslinked product according to an embodiment of the present disclosure. Applicable parts of the polymer and the crosslinked product are not specifically limited, and an exemplary form is that an electric wire composing a wiring harness includes the electric wire 1 having the polymer or the crosslinked product according to an embodiment of the present disclosure as the insulation coat 3. The polymer or the crosslinked product can further be suitably used in the wiring harness at a connecting portion between a terminal and a conductor, and at portions of an exposed conductor or the terminal material to be waterproofed, as a curable material or a molding material which covers the surface of a metal material, such as a wire conductor or a terminal material. The polymer can be particularly suitably used as a curable material, while the crosslinked product can be suitably used as the molding material. In each portion, the polymer and the crosslinked product can compose a covering that is excellent in each characteristic, including convenience in molding, heat resistance against heat by energization, corrosion prevention for the covered metal material, and peelability in a manner that takes advantage of characteristics of the polymer and the crosslinked product.

### EXAMPLE

The embodiments will be described. The present disclosure is not limited to the embodiments. Unless otherwise stated, the preparation and the evaluation of samples were carried out in the air at room temperature.

### <Preparation of Sample>

For samples A1 to A9 and samples B1 to B8, material mixture solutions are prepared. That is, each component, mentioned in Table 1 described later, is prepared in accordance with a blending ratio of Table 1, and an epoxy compound (an epoxy monomer or an epoxy-modified resin) was stirred at 50° C. for 1.5 hours with 9 times the amount of xylene. The mixture solution was brought back to room temperature.

Next, a solid sample is prepared by using the material mixture solution. Each material mixture solution in which a fatty acid salt or an amine curing agent is added to an epoxy compound (the entire gelled product if gelled) was filled into a 30 mm×30 mm×30 mm Teflon frame (Teflon is a registered trademark; hereafter the same), and after air-dried, further vacuum-dried to remove xylene. Further, the sample was left in an oven at 180° C. for 10 minutes to heat for reaction (polymerization or crosslinking reactions) and then brought back to room temperature. If the sample was solidified, the sample was removed from the Teflon frame. Meanwhile, if the sample was prepared by adding a cationic curing agent to the epoxy compound, the material mixture solution was irradiated with ultra-violet rays with a UV lamp (manufactured by SEN LIGHTS CORPORATION; 100 mW/cm²) for 5 minutes for reaction (polymerization or crosslinking reactions).

Each component used for preparing the sample is as follows:

### (1) Epoxy Monomer

CH-ep: 3′,4′-epoxy cyclohexanecarboxylic acid 3,4-epoxy cyclohexyl methyl, molecular weight 252.3, liquid at room temperature, epoxy equivalent amount 126 g/eq; manufactured by Fujifilm Wako Pure Chemicals Corporation)
OD-ep: 1,2-epoxyoctadecane (molecular weight 268.5, flow-starting temperature 27° C., epoxy equivalent amount 269 g/eq; Tokyo Kasei Co., Ltd.)

### (2) Epoxy-Modified Resin

BF-E: BONDFAST BF-E (ethylene glycidyl methacrylate copolymer; average molecular weight 2.2×10⁵, flow-starting temperature 110° C., epoxy equivalent amount 1185 g/eq; manufactured by Sumitomo Chemical).
BF-7M: BONDFAST BF-7M (ethylene glycidyl methacrylate copolymer; average molecular weight 1.9×10⁵, flow-starting temperature 55° C., epoxy equivalent amount 2370 g/eq; manufactured by Sumitomo Chemical).

### (3) Fatty Acid Salt (Metal Soap)

st-Li: Lithium stearate (molecular weight 290.4; melting point 220° C.; manufactured by FUJIFILM Wako Pure Chemicals Corporation.)
st-Mg: Magnesium stearate (molecular weight 591.3; melting point 200° C.; manufactured by Fujifilm Wako Pure Chemicals Corporation)
st-Ca: Calcium stearate (Molecular weight 607.0; melting point 180° C.; manufactured by Fujifilm Wako Pure Chemicals Corporation)
st-Zn: Zinc stearate (molecular weight 632.3; melting point 128° C.; made by Fujifilm Wako Pure Chemicals Corporation)

### (4) Amine Curing Agent

DTA: Diethylenetriamine (molecular weight 103.2, liquid at room temperature, amine active hydrogen equivalent amount 21 g/eq; Tokyo Kasei Co., Ltd.)

### (5) Cationic Curing Agent (Initiators, Photoacid Generators)

WPI-116: Bis[n-alkyl(C10-13)phenyl]iodonium hexafluoroantimonate (50% propylene carbonate solution; molecular weight 853.5 (n=12); Fujifilm Wako Pure Chemicals Corporation)

### <Evaluation Method>

### (1) Flow-Starting Temperature

In the process of preparing each sample described above, the sample was left in an oven at 180° C. for 10 minutes, and thereafter the status of the content within the Teflon frame was confirmed using a spatula, and if the content was in a liquid form, the polymerization or the crosslinking was considered not to be taken place (indicated in Table 1 as “L”). Meanwhile, the content was solidified, the content was removed from the Teflon frame, cut into 10 mm (length)×10 mm (width)×2 mm (thickness) specimens, and a flow-starting temperature was measured.

In the process of measuring the flow-starting temperature, the specimen was put onto a hot plate with variable temperatures, and thereafter a 2 mm p cylindrical indenter with a dial gauge on top was pressed against the center of the specimen with a force of 1 N. The distance of the indenter entering into the sample was then recorded while the temperature of the hot plate was increased at a rate of 5° C./min. The temperature at which the penetration of the intender reached 2.0 mm (when the specimen penetrated) was recorded as the flow-starting temperature. The polymerization or crosslinking reactions were considered to have taken place when the flow-starting temperature of the specimen was increased by 10° C. or higher compared to the epoxy compound without the fatty acid salt and the amine curing agent or the cationic curing agent.

### (2) Acidity of Water Extract

Each solidified specimen was scaled and taken 1 g, then cut into small pieces and put into a pressure-resistant bottle to which 10 g of pure water was added and sealed. The pressure-resistant bottle was heated in an oven at 120° C. for 24 hours while occasionally shaken, and an extraction was performed. Thereafter, the pressure-resistant bottle was brought back to room temperature, and only an aqueous phase was collected with a pipette, thereby measuring the acidity of water extract using a pH meter.

### (3) Metal Peelability

In the sample preparation process described above, for a solidified sample obtained by heating in an oven at 180° C., the material mixture solution before curing was poured into a 30 mm (length)×5 mm (width)×5 mm (thickness) Teflon frame placed on a copper plate. At this time, to secure a grip portion for peeling off after the polymerization or crosslinking, 5 mm of one end of the copper plate in a longitudinal direction was protected by a Teflon tape in order not to contact the copper plate with the material mixture solution. Thereafter, similar to the sample preparation process described above, the sample was air-dried, vacuum-dried to remove xylene, and left in an oven at 180° C. for 10 minutes to heat for reaction and then brought back to room temperature.

Further, after removing the Teflon frame and grabbing the grip portion, a solidified layer was pulled in a direction perpendicular to the copper plate with a tensile tester, and peelability was confirmed. If the material was easily peeled off, the sample was evaluated as excellent peelability (A) while if the material was broken before being peeled off or left its fragments on the copper plate after being peeled off, the sample was evaluated as poor in metal peelability (B).

(4) Fluidity after Heating at 90° C.

In the sample preparation process described above, for the solidified sample obtained by heating in an oven at 180° C., the material mixture solution before curing was poured into a 30 mm (length)×30 mm (width)×3 mm (thickness) Teflon frame, and after air-dried, further vacuum-dried to remove xylene. Further, the sample was left in an oven at 90° C. for 10 minutes and then brought back to room temperature, and the status of the content within the Teflon frame was confirmed using a spatula. If the sample was in a liquid form, the polymerization was considered not to take place by heating at 90° C. (indicated in Table 1 as “L”). Meanwhile, if the sample was confirmed to be solidified, the sample was removed from the Teflon frame, cut into 10 mm (length)×10 mm (width)×2 mm (thickness) specimens, and a flow-starting temperature was measured using the same method as described in the evaluation in the above-described (1) flow-starting temperature. This operation conformed to the polymerization or crosslinking reactions that took place at 90° C.

### (6) Confirmation for Product

Infrared absorption spectroscopy (FT-IR) was used to confirm what compound was formed as a solid product when heating the material mixture solution, including the epoxy compound and the fatty acid salt, to form a solid product. Here, sample AS, in which OD-ep was used as the epoxy compound and st-Mg was used as the fatty acid salt, was representatively analyzed. FT-IR measurements were performed only for the status of OD-ep (i) before heating and (ii) after heating at 150° C. for 5 minutes. In addition, FT-IR measurements were performed for the mixture solution (i.e., the mixture solution of sample A5) in which 5 parts by mass of st=Mg was added to 100 parts by mass of OD-ep, (iii) before heating and (iv) after heating at 150° C. for 5 minutes.

### Evaluation Result

Results of various evaluations for samples A1 to A9 and B1 to B8 were listed in Table 1 below, along with the amount of each component (unit: parts by mass).

| | | | Flow- | | | | | | | | | | |
|---|---|---|---|---|---|---|---|---|---|---|---|---|---|
| | | | Starting | | | | | | | | | | |
| | | Molecular | Temperature | Equivalent | Sample Number | | | | | | | | |
| | | Weight | (° C.) | Amount* | A1 | A2 | A3 | A4 | A5 | A6 | A7 | A8 | A9 |
| Epoxy | CH-ep | 252.3 | <0 | 126 | 100 | 100 | 100 | 100 | | | | | |
| Monomer | OD-ep | 268.5 | 27 | 269 | | | | | 100 | | | | |
| Epoxy- | BF-E | 2.2 × 10⁵ | 110 | 1185 | | | | | | 100 | | | |
| Modified | | | | | | | | | | | | | |
| Resin | BF-7M | 1.9 × 10⁵ | 55 | 2370 | | | | | | | 100 | 100 | 100 |
| Fatty Acid | st-Li | 290.4 | — | — | 5 | | | | | | | | |
| Salt | st-Mg | 591.3 | — | — | | 5 | | | 5 | 5 | 5 | 1 | 20 |
| | st-Ca | 607.0 | — | — | | | 5 | | | | | | |
| | st-Zn | 632.3 | — | — | | | | 5 | | | | | |
| Amine | DTA | 103.2 | — | 21 | | | | | | | | | |
| Curing | | | | | | | | | | | | | |
| Agent | | | | | | | | | | | | | |
| Cationic | WPI-116 | 853.5 | — | — | | | | | | | | | |
| Curing | | | | | | | | | | | | | |
| Agent | | | | | | | | | | | | | |

| | | | | | | | | | |
|---|---|---|---|---|---|---|---|---|---|
| Flow-Starting Temperature (° C.) | 250 | 235 | 220 | 260 | 220 | >270 | >270 | >270 | >270 |
| Extracted Water pH | 7.5 | 7.8 | 7.5 | 7.6 | 7.7 | 6.7 | 6.6 | 6.8 | 7.3 |
| Metal Peelability | A | A | A | A | A | A | A | A | A |
| Flow-Starting Temperature(° C.) after heating at 90° C. | L | L | L | L | <35 | 111 | 55 | 55 | 60 |

| | | | Flow- | | | | | | | | | |
|---|---|---|---|---|---|---|---|---|---|---|---|---|
| | | | Starting | | | | | | | | | |
| | | Molecular | Temperature | Equivalent | Sample Number | | | | | | | |
| | | Weight | (° C.) | Amount* | B1 | B2 | B3 | B4 | B5 | B6 | B7 | B8 |
| Epoxy | CH-ep | 252.3 | <0 | 126 | 100 | | 100 | | | 100 | | |
| Monomer | OD-ep | 268.5 | 27 | 269 | | | | 100 | | | 100 | |
| Epoxy- | BF-E | 2.2 × 10⁵ | 110 | 1185 | | 100 | | | 100 | | | 100 |
| Modified | | | | | | | | | | | | |
| Resin | BF-7M | 1.9 × 10⁵ | 55 | 2370 | | | | | | | | |
| Fatty Acid | st-Li | 290.4 | — | — | | | | | | | | |
| Salt | st-Mg | 591.3 | — | — | | | | | | | | |
| | st-Ca | 607.0 | — | — | | | | | | | | |
| | st-Zn | 632.3 | — | — | | | | | | | | |
| Amine | DTA | 103.2 | — | 21 | | | 16 | 8 | 2 | | | |
| Curing | | | | | | | | | | | | |
| Agent | | | | | | | | | | | | |
| Cationic | WPI-116 | 853.5 | — | — | | | | | | 2 | 2 | 2 |
| Curing | | | | | | | | | | | | |
| Agent | | | | | | | | | | | | |

| | | | | | | | | |
|---|---|---|---|---|---|---|---|---|
| Flow-Starting Temperature (° C.) | L | 110 | 148 | <35 | >270 | 225 | 205 | >270 |
| Extracted Water pH | — | 7.4 | 11.1 | 10.7 | 10.1 | 2.1 | 2.0 | 1.9 |
| Metal Peelability | — | B | B | — | B | A | A | A |
| Flow-Starting Temperature(° C.) after heating at 90° C. | — | 110 | 136 | <35 | >270 | 218 | 200 | >270 |

*Epoxy Equivalent Amount(g/eq), or Amine Active Hydrogen Equivalent Amount(g/eq)

According to Table 1, in either one of samples A1 to A5 which uses the mixture solution of the epoxy monomer to which the fatty acid salt was added, and samples A6 to A9 which uses the mixture solution of the epoxy-modified resin to which the fatty acid salt was added, the flow-starting temperature was higher than 200° C. which is remarkably higher than that of the epoxy compound alone. Therefore, the epoxy compound is considered to cause the polymerization or crosslinking reactions and solidified in each mixture solution after heating at 180° C. Although there are remarkable differences in flow-starting temperature of an employed epoxy compound between samples A1 to A4 and sample A5, and between samples A6 and A7, there are no remarkable differences in flow-starting temperature when the fatty acid salt was added to cause the reaction. Therefore, a high flow-starting temperature can be obtained through the polymerization or crosslinking reactions, even if the epoxy compound as a raw material has a different flow-starting temperature. There are no remarkable differences in flow-starting temperature due to differences in the fatty acid salt. Although samples A7 to A9 have the fatty acid salt in different addition amounts with each other, the flow-starting temperature of 270° C. or higher was obtained in each sample, indicating that the crosslinking reaction was sufficiently progressed at either addition amount.

Further, in either one of samples A1 to A5 and samples A6 to A9, the acidity of the water extract is pH 6.0 to 8.0, which verifies that no acidic or basic product had been generated. Metal peelability is also favorable, which verifies that no adhesion of the polymer and the crosslinked product to a metal surface via a hydroxyl group is found. In addition, in either one of these samples, there is no remarkable change in the flow-starting temperature of the epoxy compound after heating at 90° C. from the flow-starting temperature of the epoxy compound of a raw material. From these facts, a confirmation is made as to that the polymerization or crosslinking reactions verified by heating at 180° C. as described above did not take place at a temperature of 90° C., and the material mixture solution at a temperature of 90° C. is stably maintained without causing any reaction.

Corresponding to the fact that the fatty acid salt and various curing agents are absent, sample B1 remains in a liquid form similar to the original epoxy monomer, even if undergoing heating at 180° C., and the polymerization reaction is found not to have taken place. Corresponding to the fact that the fatty acid salt and various curing agents are absent, sample B2 is also considered that the crosslinking reaction has not taken place because no change in flow-starting temperature is seen from the original epoxy-modified resin even heating at 180° C. The poor metal peelability in sample B2 is considered to be due to the formation of the hydroxyl group at a metal interface by the epoxy group.

For samples B3 to B5, no fatty acid salt is added, and the amine curing agent is added instead. Among these samples, samples B3 and B5 have the epoxy compound in which a plurality of the epoxy groups are included in a molecule, and flow-starting temperatures of samples B3 and B5 increased via heating at 180° C.; accordingly, the polymerization or crosslinking reactions are considered to be progressed in each epoxy compound. However, these reactions take place by an addition polymerization using the amine curing agent, which corresponds to poor metal peelability. The poor metal peelability may be due to the hydroxyl group having hydrogen-bonding properties being generated in the polymer or the crosslinked product at the time of the addition polymerization. The reason that sample B3 has the flow-starting temperature lower than samples A1 to A4 is that a molecule of the amine curing agent is incorporated into a polymer chain of the polymer of the epoxy monomer, and the polymer chain can no longer be arranged in a highly uniform manner. The acidity of the water extract becomes high, such as pH 10 or higher. This high acidity is due to the amine curing agent or a basicity of an amino group included in the polymer or the crosslinked product. The flow-starting temperature after heating at 90° C. is approximately the same as that heating at 180° C., and the polymerization and the crosslinking reactions were almost completed at 90° C.

Sample B4 uses a mono-epoxy compound which includes only one epoxy group in a molecule of the epoxy monomer; accordingly, the amine curing agent, which is mono-amine, can not cause the polymerization. Corresponding to the above-mentioned fact, almost no increase in the flow-starting temperature is seen. The metal peelability can not be evaluated due to the sample having brittleness and a low melting point.

In samples B6 to B8, no fatty acid salt is added, and the cationic curing agent is added instead. The flow-starting temperature of each sample is increased to 200° C. or higher, corresponding to the progress of the cationic polymerization. The water extract, however, takes a low value such as pH3 or lower. The above-mentioned fact may be due to the acidification of the cationic curing agent remaining in the material. The flow-starting temperature after heating at 90° C. is approximately the same as that heating at 180° C., and the polymerization and the crosslinking reactions are almost completed at 90° C.

As described above, comparisons between samples A1 to A9 and samples B1 to B8 show that the polymer or the crosslinked product having favorable metal peelability can be produced by adding the fatty acid salt to the epoxy compound through heating at 180° C., without the hydroxyl group or acid being generated. Further, this reaction does not take place in a relatively lower temperature range, such as 90° C. or lower, showing the controllability of the reaction.

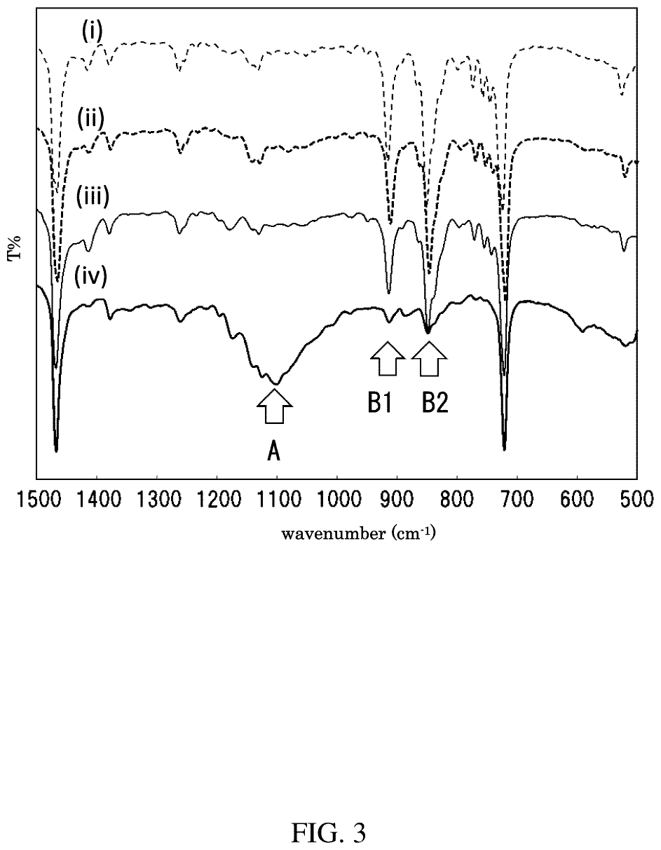

Finally, the result of FT-IR measurement measured for the material corresponding to sample AS is illustrated in FIG. 3. (i) shows the status before heating the epoxy monomer alone; (ii) shows the status after heating (i) at 150° C.; (iii) shows the status before heating the mixture to which the fatty acid salt is added, and (iv) shows the status after heating (iii) at 150° C. First, for (i) and (ii) to which no fatty acid salt is added, no remarkable change is shown in a spectrum before or after heating, and almost the same strength is maintained in an absorption peak of the epoxy group between 910 cm-1 and 840 cm-1 (i.e., peaks B1 and B2). That is, heating the epoxy monomer alone without adding the fatty acid salt does not cause a reaction, such as polymerization, nor cause a remarkable change in chemical state of the epoxy monomer.

Meanwhile, a comparison of the spectrum between (iii) and (iv) to which the fatty acid salt was added shows a remarkable decrease in strength of the peak of the epoxy group (i.e., peaks B1 and B2) in (iv) after heating compared with (iii) before heating. On the other hand, a new broad peak (i.e., peak A) appeared around 100 cm. This new peak is characteristic of an ether bond (i.e., C—O—C asymmetry stretching). From these facts, the reaction involving ring-opening of the epoxy group and the formation of ether bonds is found to be in progress, as the fatty acid salt is added to the epoxy compound and heated. That is, the polymer having a structure shown in formula (1) is formed through the polymerization reaction.

### LIST OF REFERENCE NUMERALS

1 Electric wire
2 Conductor
3 Insulating covering

1. A polymer having a structure represented by formula (1) below, wherein
the polymer has a flow-starting temperature of 150° C. or higher,
when the polymer is immersed in pure water in 10 times the mass of the polymer at 120° C. for 24 hours to obtain water extract, the water extract has an acidity of pH 4 or higher and 9 or lower, and
the polymer does not comprise a compound causing ring-opening polymerization of an epoxy group, except for a fatty acid salt, or a chemical species that is derived from the compound and remains after undergoing the ring-opening polymerization of the epoxy group: 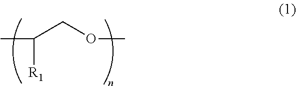
where R₁ is an organic group and “n” is an integer of 2 or larger,
the structure represented by formula (1) is obtained by undergoing ring-opening polymerization of an epoxy monomer represented by formula (2) below by a fatty acid salt:

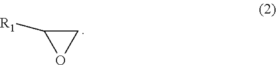

2. The polymer according to claim 1, wherein the polymer is composed of a repeating unit in formula (1) alone, except for end portions.

3. The polymer according to claim 1, wherein the polymer does not comprise an acid group or a basic group.

4. The polymer according to claim 1, wherein the polymer does not comprise a component having an acid group or a basic group.

5. The polymer according to claim 1, wherein the polymer does not comprise an amine compound, a hydroxyl-containing compound, or isocyanate, and a chemical species that are derived from these compounds and remain in a material.

6. A crosslinked product having a structure represented by formula (3) below, wherein
the crosslinked product has a flow-starting temperature of 150° C. or higher,
when the crosslinked product is immersed in pure water in 10 times the mass of the crosslinked product at 120° C. for 24 hours to obtain water extract, the water extract has an acidity of pH 4 or higher and 9 or lower, and
the crosslinked product does not comprise a compound causing ring-opening polymerization of an epoxy group, except for a fatty acid salt, or a chemical species that is derived from the compound and remains after undergoing the ring-opening polymerization of the epoxy group: 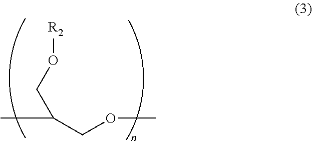
where R₂ is a polymer chain and “n” is an integer of 2 or larger,
the structure represented by formula (3) is obtained by undergoing ring-opening polymerization of an epoxy-modified polymer represented by formula (4) below by a fatty acid salt:

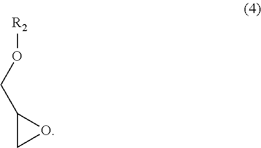

7. The crosslinked product according to claim 6, wherein the crosslinked product is composed of a repeating unit in formula (3) alone, except for end portions.

8. The crosslinked product according to claim 6, wherein the crosslinked product does not comprise an acid group or a basic group.

9. The crosslinked product according to claim 6, wherein the crosslinked product does not comprise a component having an acid group or a basic group.

10. The crosslinked product according to claim 6, wherein the crosslinked product does not comprise an amine compound, a hydroxyl-containing compound, or isocyanate, and a chemical species that are derived from these compounds and remain in a material.

11. An electric wire comprising:
a conductor comprising a metal; and
an insulation coat comprising the polymer according to claim 1, covering an outer periphery of the conductor.

12. A wiring harness, comprising the polymer according to claim 1.

13. A method for producing a polymer, comprising a step of heating a composition to cause a polymerization reaction, the composition comprising the epoxy monomer represented by formula (2) above and the fatty acid salt, without comprising a compound causing the ring-opening polymerization of the epoxy group, except for the fatty acid salt, to thereby produce the polymer according to claim 1.

14. The method for producing a polymer according to claim 13, wherein the polymerization reaction starts at 100° C. or higher.

15. The method for producing a polymer according to claim 13, wherein the composition does not comprise an amine compound, a hydroxyl-containing compound, or isocyanate.

16. A method for producing a crosslinked product, comprising a step of heating a composition to cause a crosslinking reaction, the composition comprising the epoxy-modified polymer represented by formula (4) above and the fatty acid salt, without comprising the compound causing the ring-opening polymerization of the epoxy group, except for the fatty acid salt, to thereby produce the crosslinked product according to claim 6.

17. The method for producing a polymer according to claim 16, wherein the crosslinking reaction starts at 100° C. or higher.

18. The method for producing a crosslinked product according to claim 16, wherein the composition does not comprise an amine compound, hydroxyl-containing compound, or isocyanate.

19. An electric wire comprising:
a conductor comprising a metal; and
an insulation coat comprising the polymer according to claim 6, covering an outer periphery of the conductor.

20. A wiring harness, comprising the polymer according to claim 6.
